(19) United States
(12) Patent Application Publication
(10) Pub. No.: US 2026/0186472 A1
(43) Pub. Date: Jul. 2, 2026

(54) DIE PAIRING MANUFACTURING PROCESS

(71) Applicant: NVIDIA Corp., Santa Clara, CA (US)

(72) Inventors: Colin Sprinkle, Sunnyvale, CA (US); Luai Nassar, San Jose, CA (US); Yin Fung Tang, San Jose, CA (US); Manas Mandal, Palo Alto, CA (US)

(73) Assignee: NVIDIA Corp., Santa Clara, CA (US)

(21) Appl. No.: 19/007,989

(22) Filed: Jan. 2, 2025

(51) Int. Cl. G05B 19/418

(52) U.S. Cl. CPC G05B 19/41875; G05B 2219/45032

(57) ABSTRACT

An integrated circuit die binning process involves forming a batch of singulated die, configuring intersection regions of a multi-dimensional control structure with settings indicating die grouping compatibility, identifying a first die with the lowest die grouping compatibility, and randomly selecting a second die for grouping with the first die or voiding the first die from one dimension of the control structure, repeating these actions for more die from the batch.

### BACKGROUND

When large-scale integrated circuits are manufactured, they are tested and ‘binned’ according to their capabilities. For instance, a circuit die may exhibit no defects, and so it go into a no-defect ‘bin’. Another die may comprise a defective internal component, and so it will go into a ‘bin’ for that type of defect, and so on. The number of bins is typically limited for practical reasons.

The bin limit may create complications when more than one large-scale integrated circuit is manufactured on the same substrate. For example, suppose each integrated circuit die comprises 50 internal components of a certain type, and two such die are manufactured on the same substrate and integrated together into an even larger integrated circuit. In the larger circuit, at least 90 of the internal components of the certain type must pass operational tests in order for the larger circuit to be commercially viable. There are many die pair combinations that meet this minimum threshold: 50 pass in die one and 40 pass in die two, 49 pass in die one and 41 pass in die two, 48 pass in die one and 42 pass in die two, and so on.

In this example, there may be hundreds, even thousands, of different configurations of bins that all satisfy the constraint that the die combination includes at least (or exactly) 90 operational components of a certain type. Conventional binning approaches may become cumbersome and unworkable in these scenarios. Binning approaches that suffice may be devised, but at the expense of yield, because it is impractical for binning strategies to completely account for all the possible permutations of configurations that may arise in manufacturing.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a die testing, pairing, and packaging system in one embodiment.

FIG. 2 depicts a multi-dimensional control structure utilized for determination of die pairings (tuple bins).

FIG. 3 depicts a process that applies the control structure depicted in FIG. 2 to form die pairs/bins.

FIG. 4 depicts the multi-dimensional control structure of FIG. 2 after voiding of a primary die and a secondary die.

FIG. 5A-FIG. 5C depict various die pairing options.

FIG. 6 depicts a parallel processing unit in accordance with one embodiment.

FIG. 7 depicts a general processing cluster in accordance with one embodiment.

FIG. 8 depicts a memory partition unit in accordance with one embodiment.

FIG. 9 depicts a streaming multiprocessor in accordance with one embodiment.

FIG. 10 depicts a processing system in accordance with one embodiment.

FIG. 11 depicts an exemplary processing system in accordance with another embodiment.

### DETAILED DESCRIPTION

Mechanisms are disclosed herein involving a solver system that reads test results from dies on a wafer and determines which dies to pair together. The solver is designed to optimize the die yield from the wafer and takes into account parameters such as IDDQ, SPEEDO, and the minimum operating voltages of the die (Vmin) to optimize the pairing for power consumption. This may result in improved performance of the die combination with no yield loss.

IDDQ, or I_DQ, is a measure of the quiescent or standby current in a digital circuit. It is the current that flows through the circuit when it is not actively switching or performing any operations. Monitoring IDDQ can be used in the testing of integrated circuits to detect faults such as stuck-at faults and bridging faults. By measuring the IDDQ of a circuit, deviations from the expected quiescent current may indicate the presence of defects or malfunctions in the circuit. This may be useful in identifying and correcting faults in digital circuits.

SPEEDO refers to Single-Point Emitter-Drain Output. SPEEDO characterizes the performance of semiconductor devices, particularly field-effect transistors (FETs). SPEEDO measures the output characteristics of a FET by applying varying voltages at the gate and drain terminals and observing the resulting current and voltage relationships. This characterizes the device's behavior under different operating conditions. SPEEDO testing is important for verifying the functionality and performance of semiconductor devices during the manufacturing process.

Complex circuits may manifest failure states even after manufacturing stress testing. These failure conditions may be repaired in the field by re-enabling redundant components in the circuit that were intentionally disabled during manufacturing in order to make the circuit to conform to requirements of a particular product Stock Keeping Unit (SKU).

Examples of circuitry that may be redundant in an integrated circuit such as a graphics processing unit are memory channel controllers and processing cores.

Some circuits are so complex that they may be implemented on multiple die (chips). Not every chip of a multi-chip circuit will have a spare component of a particular type available to enable in place of a defective one. Even if a spare component is available in the chip, the spare component may not be physically located such that it may be effective at replacing a defective one.

Disclosed herein are mechanisms that improve the binning process for dies for use in multi-die circuits, e.g., graphics processing units, machine memories, or other advanced data processors or controllers. The binning process may involve forming a batch of singulated die, configuring intersection regions of a multi-dimensional control structure with settings indicating die grouping compatibility, identifying a first die with the lowest die grouping compatibility, and randomly selecting a second die for grouping with the first die or voiding the first die from one dimension of the control structure. These actions may be repeated while there are more die from the batch suitable for grouping/binning.

In one embodiment, the disclosed mechanisms determine the potential repairability of dies of when determining the dies to be paired. A repairability metric may be determined for each candidate die pairing. This metric may be determined by simulating defects on pairs of component types for which repairability is a consideration in pairing decisions (e.g., on every potential pairing of processor core and memory channel controller components).

Based on these metrics, a determination is made on whether or not the available spare components in the die may be re-enabled to successfully recover the functionality of the die to fit particular SKU requirements. In one embodiment, die pairs manifesting a highest repairability metric overall are selected and implemented.

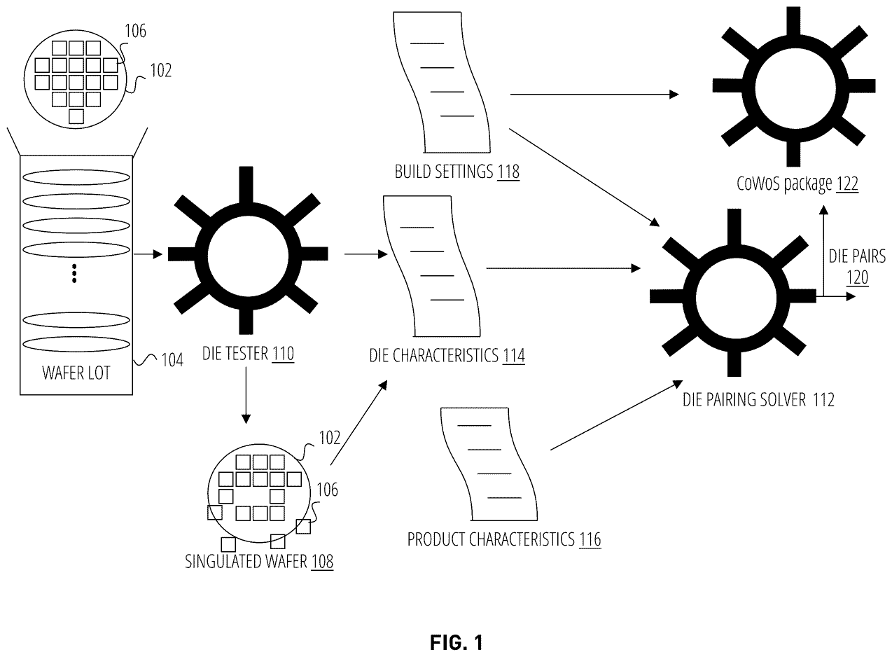

FIG. 1 depicts a die testing, pairing, and packaging system in one embodiment. A wafer 102 from a manufactured wafer lot 104 comprises a plurality of die 106 that are singulated, resulting in a singulated wafer 108. The singulated die 106 then undergo testing by a die tester 110. A solver 112 system inputs die characteristics 114 generated by the die tester 110, along with product characteristics 116 (characteristics of products that will incorporate the die 106) and build settings 118 (settings to apply when packaging the die 106). The solver 112 transforms these inputs into a set of die pairs 120.

The product characteristics 116 may take the form of SKU attributes. SKUs comprise a set of attributes, requirements, and/or constraints (i.e., collectivelly referred to herein as simply ‘attributes’ for conciseness) assigned to dies sold or used in a product for particular purposes. The attributes of a specific die SKU may for example be that the die must have a certain or minimum number of functioning internal components of a particular type.

In one embodiment, an entire wafer lot 104 may be singulated and tested to form a batch of die from which the solver 112 generates the die pairings for different SKUs.

The die pairings may be applied for example to form a CoWoS package 122. CoWoS is shorthand for Chip-on-Wafer-on-Substrate, a semiconductor packaging technology that integrates multiple die onto a common substrate to improve performance and reduce interconnect delays.

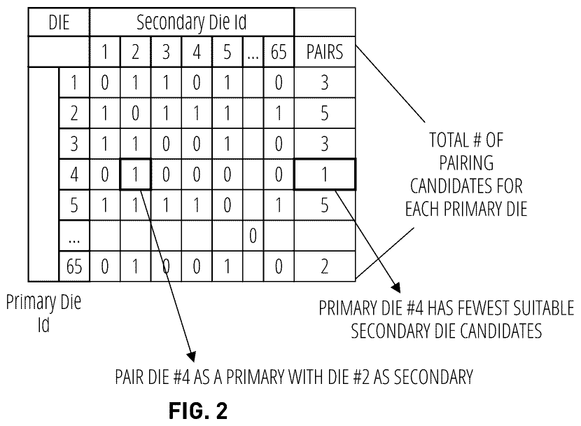

FIG. 2 depicts a multi-dimensional control structure utilized for determination of die pairings (tuple bins). The control structure may be extended for grouping die into n-die bins (e.g., a grouping of n-die for a particular product SKU). The die to group may be substantially identical in terms of their internal circuitry (e.g., die singulated from the same silicon wafer) or may be of different construction.

The die to be binned may be from a set singulated from a single wafer or from a set formed from the die from many wafers. In one embodiment, the control structure may be utilized to form die pairings for die singulated from individual wafers, and then a ‘virtual wafer’ is formed comprising any unpaired die left over from these pairings, and the algorithm is applied to form die pairings from the virtual wafer.

One such two-dimensional (2D) binning control structure depicted in FIG. 2 may be configured per bin/product SKU for which die pairings are needed. Binning for SKUs comprising more than two die may be implemented by extending the dimensionality of the utilized matrices, e.g., utilizing 3D matrices to bin groups of three die, 4D matrices to bin groups of four die, and so on.

In the exemplary die pairing/binning multi-dimensional control structure depicted in FIG. 2, one dimension represents candidates for a first die (the ‘primary’) of a pair of die, and a second dimension represent candidates for a second die (the ‘secondary’) to pair with the primary. The intersection regions of the dimensions are configured with a ‘1’ (or other distinct setting) to indicate that, for a defined SKU or bin, the primary die and the secondary die comprise a compatible/candidate die pairing. The intersection regions are configured with a ‘0’ (or other distinct setting) to indicate that, for a defined SKU or bin, the primary die and the secondary die do not comprise a suitable or compatible pairing (e.g., the pairing fails to satisfy the SKU's requirements for a certain amount of functional/non-defective internal circuitry).

For example, primary die #4 and secondary die #2 make a suitable pairing for the bin/SKU for which the table/matrix is configured, and therefore a ‘1’ appears in the intersection of row #4 and column #2.

A die cannot be a candidate for pairing with itself, and therefore the diagonal region of the control structure configured with all ‘0’s. The right-most column comprises a sum of the ‘1’s across each row, i.e., the last column comprises the total number of secondary die candidates suitable for pairing with each primary die candidate for a particular bin/SKU. (In general, these totals may be in any column or other dimension of the control structure, or maintained in a separate memory region from the control structure). In the depicted example, primary die #4 has the fewest suitable secondary die pairing candidates.

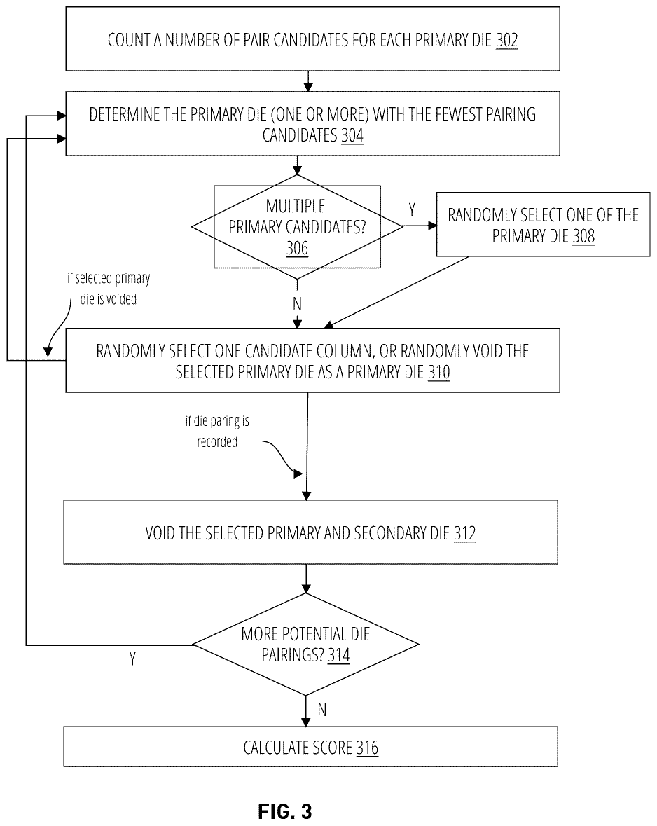

FIG. 3 depicts a process that applies the control structure depicted in FIG. 2 to form die pairs/bins. Once the control structure is configured for a particular bin/SKU, a count of candidate secondary die is determined for each primary die (action 302). Any primary die from the singulation batch under evaluation that do not have any secondary die pairing candidates may be excluded from inclusion in the control structure, and may be floorswept as defective, or put aside for further processing stages.

The primary die with the fewest secondary die pairing candidates is/are determined (action 304). In the case of a tie, the determination may yield multiple primary die (decision block 306). If that is the case, one of the determined primary die is randomly or pseudo-randomly selected (action 308). The randomization of the selection may in fact be pseudo-random due to the impracticality of implementing true-theoretical random selection. Herein, ‘random’ shall be understood to encompass pseudo-randomization as well. One of two possible actions may then be performed (actions 310).

First, in cases where the count of candidate secondary die for the selected primary die exceeds one (1), one of the candidate secondary die suitable for pairing with the selected die may be randomly selected to pair with the primary die. If only one secondary die is a suitable pairing candidate, that secondary die may be selected (in which case the selection is not random but rather determined by the availability of only a single choice). The determined pairing of primary and secondary die is then recorded for further processing/manufacturing of the corresponding SKU.

Second, and alternatively, the selected primary die may be randomly voided as a primary die candidate altogether (it may remain a secondary die candidate for pairing with other die). In one embodiment, to void a die as a primary candidate, the row entries for that die are set to ‘0’ or other distinct setting in the control structure.

The selection between taking the first action or alternatively the second action may itself be randomly determined.

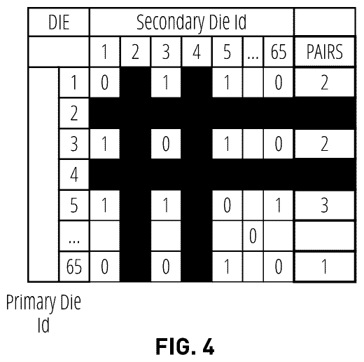

Once a pairing of a primary die and a secondary die is recorded, the primary die and the secondary die are voided from the control structure (action 312). The candidate secondary die totals are updated to reflect the voiding of the primary and secondary die. See FIG. 4.

On conditional that there are more potential die pairings indicated in the control structure (decision 314), the process of forming die pairings described supra repeats. Otherwise, a score for the round of die pairings thus concluded is calculated (action 316). The score is utilized to provide a metric of success for the round of pairings thus concluded.

In one embodiment, a score Sₙ comprises the number of pairings obtained. More refined score metrics may also be calculated to characterize the round of pairings for comparison, e.g., the incorporation of a power score.

For example, each die found suitable for pairing for a particular bin/SKU may be assigned a value based on the die's tested power consumption, e.g., a ‘power value’ p that captures variations in power consumption due to operational differences among the die. In general, the scoring may take into account any parameter or characteristic assigned to the die that is sought to be minimized (or maximized) in the aggregate pairing outcomes in a round.

In one embodiment, a power score Sₚ for the round may be calculated as follows:

$${S}_{p} = α / max ( {p}_{i} , P )$$

where pᵢ is the total power value p_{primary}+p_{secondary} for die pair pᵢ in the set P of die pairs formed in the round, and α is a scale factor that may be empirically determined for the particular implementation. It follows that the total score for a round comprising Sₙ die pairings, accounting for power consumption, is:

$${S}_{t} = β \times {S}_{n} + α / max ( {p}_{i} , P )$$

where β is a scale factor that may be empirically determined for the particular implementation.

In another embodiment, the power score for round may be calculated as:

$${S}_{p} = α / variance ( {p}_{i} , P )$$

In another embodiment, the power score for round may be calculated as:

$${S}_{p} = α / variance ( P )$$

In another embodiment, a power score for a round may be determined in a manner that obviates a division operation as follows:

$${S}_{p} = - 1 * α * max ( {p}_{i} , P )$$

and a total score for a round comprising Sₙ die pairings may be determined by:

$${S}_{t} = β \times {S}_{n} - α * max ( {p}_{i} , P )$$

Similarly a variance-based power score may be determined as:

$${S}_{p} = - 1 * α * variance ( P )$$

Due to the randomization inherent in the process, each round of die pairings from a same initial state of the control structure may yield different scores. After a configured number of pairing rounds are completed and scored, the scores may be compared, and the pairings from the round producing a ‘best’ score may be selected for further processing in the manufacturing process of the SKU for which the control structure was configured.

More generally, multiple scores (along different parameters/die die characteristics) may be computed per round, and a binning solution that is ‘best’ across the multiple scores may be selected.

Mechanisms in accordance with FIG. 2-FIG. 4 may parallelize with high efficiency on certain data processing devices such as those utilizing graphics processing units (GPUs).

The computational efficiency of the disclosed mechanisms may compare favorably to other mechanisms such as those that utilize Satisfiability Modulo Theories (SMT) solvers. The efficiency and speed of convergence of the disclosed mechanisms may make them particularly well suited to high-yield die production processes and facilities.

Satisfiability Modulo Theories) solver addresses multi-constraint problems by combining Boolean satisfiability solving with domain-specific theories such as linear arithmetic, bit-vectors, arrays, and uninterpreted functions. SMT solvers may be applied to determine whether a set of die pairing constraints is satisfiable, impossible, or impractically difficult to determine in production environments. An exemplary set of constraints that may be presented to an SMT solver is: (1) the sum of compute units for a pair of die must be ≥X, and (2) the total power consumption of a pair of die must be ≤Y. The SMT solver may report that the set of constraints is (a) satisfiable from a given batch of die, (b) not satisfiable from a given batch of die, (c) cannot be determined as satisfiable in an allotted time interval (timeout).

The SMT solver may be repeatedly executed on a batch of die with the constraints tightened after each iteration that is satisfiable, until a ‘not satisfiable’ or timeout condition is encountered. By this process, an optimum set of constraints that are satisfiable under timing constraints and for a particular SMT solver may be determined. The die pairings obtained via an SMT-based process may more optimally satisfy the SKU constraints than the die pairings obtained via the control structure mechanism described in conjunction with FIG. 2-FIG. 4. However, the complexity and convergence of SMT solvers may be unsuitable for some high-yield production environments.

In applications wherein the die from individual wafers are binned on a per-wafer basis, there may be left-over die from some wafers that weren't binned (e.g., paired with another die). In one embodiment, the leftover die may be grouped into a ‘virtual wafer’ and the binning process may be repeated die of the virtual wafer. In another embodiment, the leftover die may be added to the die for a next wafer to process, and the binning process may be repeated on the next wafer. In another application, identifiers for the singulated chips from a batch of wafers may be configured into the control structure, and binning may be performed on the entire batch of die.

Some components of integrated circuits may pass post-production System-Level Testing (SLT) and yet may still eventually fail when deployed in the field. Component failures may sometimes be repaired in the field, without replacing the integrated circuit, by re-enabling redundant components of the integrated circuit that were deliberately disabled post-production to meet SKU constraints.

Not every die may comprise a spare component of a particular type (e.g., a spare processor core or memory channel controller) available for use in field repair. Even if a die comprises a spare component of a particular type, the spare part may not be physically located in a manner that enables its use as a replacement for a defective part.

The probability of successfully carrying out an in-field repair may be improved by setting a repairability constraint for application by the die-binning mechanisms disclosed herein. The control structures and processes described in conjunction with FIG. 2-FIG. 4 may be configured such that die repairability is taken into account when selecting the die to include together in a SKU bin.

In one embodiment, the die pairing/binning mechanisms may operate to maximize the number of die groupings (e.g., pairs) formed from a given batch of die. This process may yield multiple solutions that yield the same count.

A repairability value may be determined for each generated grouping, calculated by simulating defects on the die components that satisfy a threshold likelihood of failure in the field (e.g., memory channel controllers and processor cores, in one embodiment) and calculating whether or not an available spares of these components in the die of the grouping are suitable to be re-enabled to repair the die pairing such that the SKU constraints are satisfied. Grouping candidates satisfying a score threshold may be selected for use in the SKU.

A given round, or multiple rounds, of die pairing runs may generate many solutions that score equally well along a primary dimension, e.g., a maximum number of die groupings in a bin for a particular SKU. From among these top outcomes, one or more bin solutions may be identified that satisfy a secondary and/or third dimension, e.g., a superior power score and/or a superior repairability score.

$${S}_{t} = β \times {S}_{n} + α / max ( {p}_{i} , P ) + γ \times {S}_{r}$$

where γ is a scale factor that may be empirically determined for the particular implementation, and Sᵣ is the number of die groups satisfying a repairability condition, e.g., comprising at least one (or, in one embodiment, a single one) of each type of spare part called for by the SKU.

In another embodiment, the score for the round may be determined by:

$${S}_{t} = β \times {S}_{n} - α * max ( {p}_{i} , P ) + γ \times {S}_{r}$$

thereby obviating the division operation.

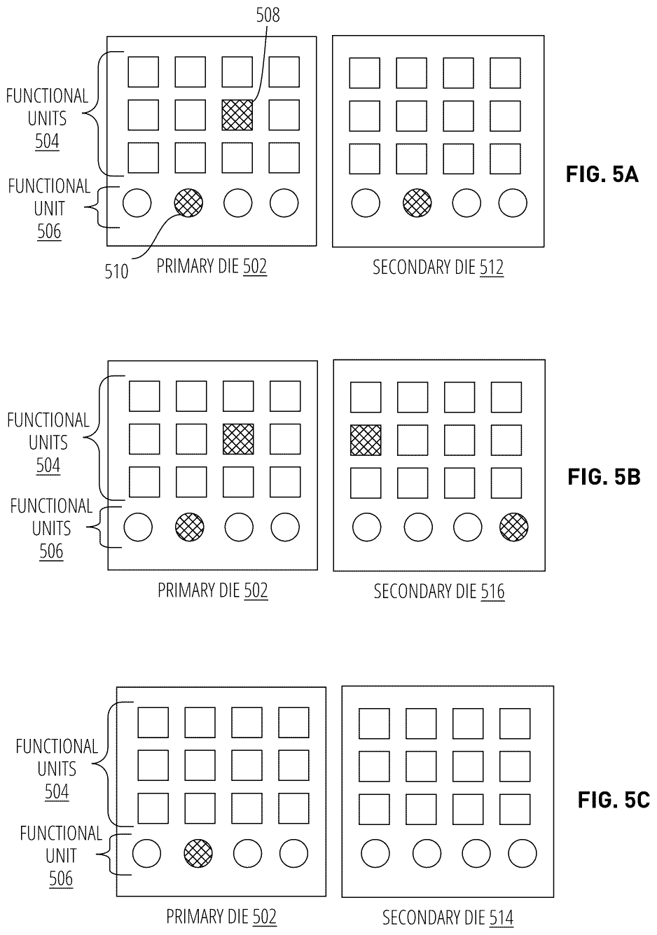

FIG. 5A-FIG. 5C depict various die pairing options. A primary die 502 comprises functional units 504 of a first type and functional unit 506 of a second type, and also a number N≥0 of defective functional units 508, 510 (hashed shading) of each type.

By way of example, a SKU constraint may be that a pair of die comprises at least 22 functional units 504 of the first type at least 5 functional units 506 of the second type. The die pairing candidates in each of FIG. 5A, FIG. 5B, and FIG. 5C meet this constraint.

A repairability score Sᵣ may be calculated for a pairing round according to a number of die pairs in the round that satisfy a repairability objective, e.g., that the die pair comprise exactly one spare (non-defective and in excess of a SKU minimum number) functional unit of each type. In one embodiment, the repairabilty score Sᵣ is the number of die pairs satisfying this constraint.

A pairing of primary die 502 with secondary die 512 as depicted in FIG. 5A may increase a repairability score for the round due to comprising a single spare functional unit 504 of the first type and a single spare functional unit 506 of the second type.

A pairing of primary die 502 with secondary die 514 as depicted in FIG. 5B may decrease a repairability score for the round, or increase it less than the die pairing candidate of FIG. 5A, due to comprising no spare functional unit 504 of the first type while providing a single spare functional unit 506 of the second type.

A pairing of primary die 502 with secondary die 516 as depicted in FIG. 5C may decrease a repairability score for the round, potentially more than the die pairing candidate of FIG. 5B, or may increase the repairability score for the round less than the die pairing candidates of either FIG. 5A or FIG. 5B, due to comprising more than a single spare functional unit 504 of the first type and more than a single spare functional unit 506 of the second type.

In one embodiment, the repairability score for a binning round is set to a number of die pairs in the round that comprise at least one (rather than exactly one) spare of one or multiple functional unit types. This repairability score may be enhanced by a number of die pairs in the round that comprise exactly one spare of one or multiple functional unit types (due to their being only a small repairability advantage to including multiple spares of a given functional unit type in a SKU).

In one embodiment, the repairability score for a binning round may be set to a number of die pairs in the round that do not comprise any spares of one or multiple functional unit types. In this embodiment, the repairability score may be subtracted to generate the total score for the round, because it indicates an impairment to die pair repairability.

The mechanisms disclosed herein may be implemented in and/or by computing devices utilizing one or more graphic processing unit (GPU) and/or general purpose data processor (e.g., a ‘central processing unit’ or CPU). For example, the disclosed mechanisms may be implemented as memories configured with machine-readable instructions that, when applied to one or more data processor (e.g., one or more GPU) may configure a computer system to implement the invention. Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

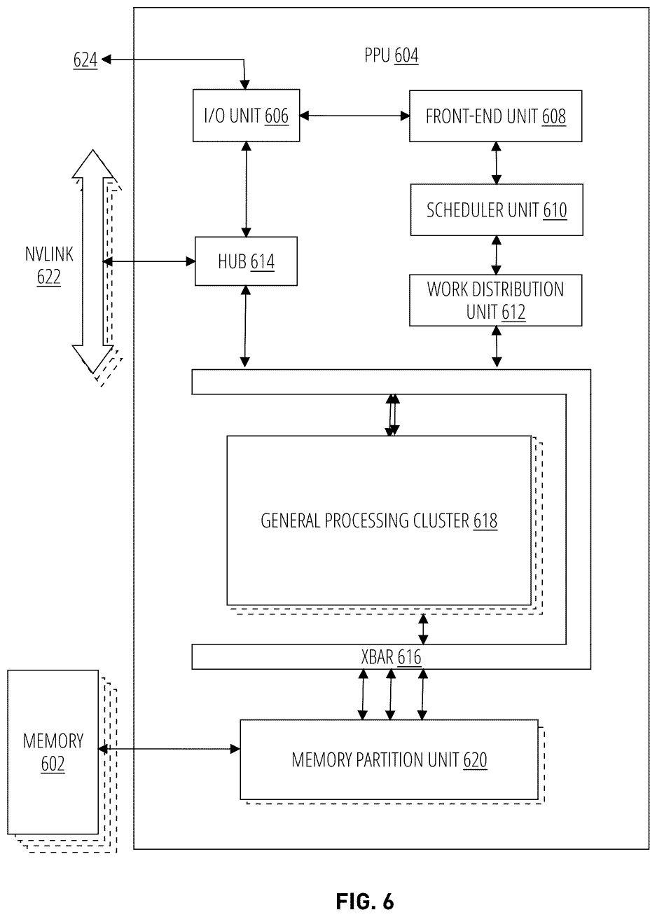

FIG. 6 depicts a parallel processing unit 604, in accordance with an embodiment. In an embodiment, the parallel processing unit 604 is a multi-threaded processor that is implemented on one or more integrated circuit devices. The parallel processing unit 604 is a latency hiding architecture designed to process many threads in parallel. A thread (e.g., a thread of execution) is an instantiation of a set of instructions configured to be executed by the parallel processing unit 604. In an embodiment, the parallel processing unit 604 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 604 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 604 modules may be configured to accelerate thousands of High Performance Computing (HPC), data center, and machine learning applications. The parallel processing unit 604 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 6, the parallel processing unit 604 includes an I/O unit 606, a front-end unit 608, a scheduler unit 610, a work distribution unit 612, a hub 614, a crossbar 616, one or more general processing cluster 618 modules, and one or more memory partition unit 620 modules. The parallel processing unit 604 may be connected to a host processor or other parallel processing unit 604 modules via one or more high-speed NVLink 622 interconnects. The parallel processing unit 604 may be connected to a host processor or other peripheral devices via an interconnect 624. The parallel processing unit 604 may also be connected to a local memory comprising a number of memory 602 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 602 may comprise logic to configure the parallel processing unit 604 to carry out aspects of the techniques disclosed herein.

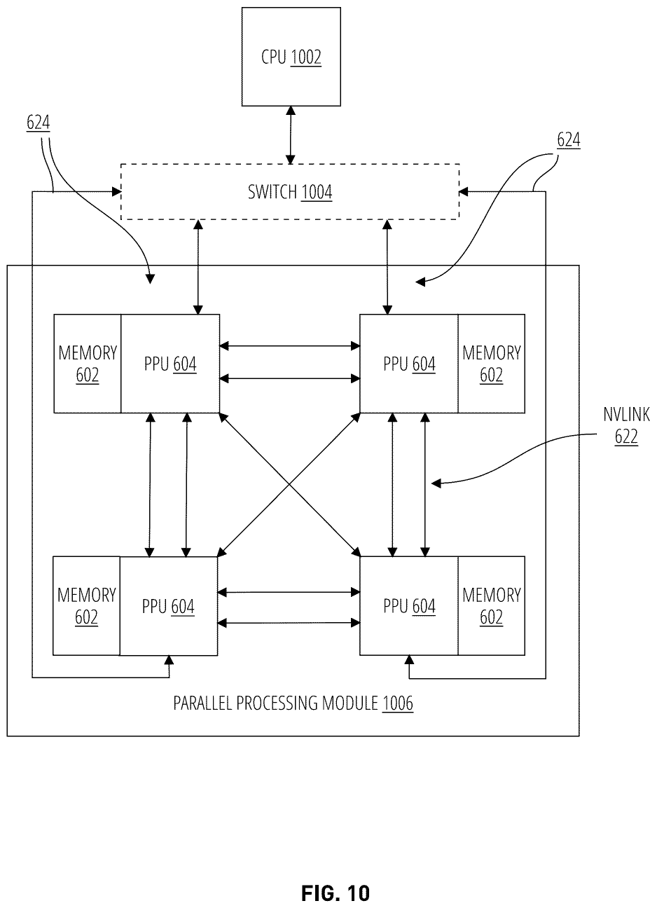

The NVLink 622 interconnect enables systems to scale and include one or more parallel processing unit 604 modules combined with one or more CPUs, supports cache coherence between the parallel processing unit 604 modules and CPUs, and CPU mastering. Data and/or commands may be transmitted by the NVLink 622 through the hub 614 to/from other units of the parallel processing unit 604 such as one or more copy engines, a video encoder, a video decoder, a power management unit, etc. (not explicitly shown). The NVLink 622 is described in more detail in conjunction with FIG. 10.

The I/O unit 606 is configured to transmit and receive communications (e.g., commands, data, etc.) from a host processor (not shown) over the interconnect 624. The I/O unit 606 may communicate with the host processor directly via the interconnect 624 or through one or more intermediate devices such as a memory bridge. In an embodiment, the I/O unit 606 may communicate with one or more other processors, such as one or more parallel processing unit 604 modules via the interconnect 624. In an embodiment, the I/O unit 606 implements a Peripheral Component Interconnect Express (PCIe) interface for communications over a PCIe bus and the interconnect 624 is a PCIe bus. In alternative embodiments, the I/O unit 606 may implement other types of well-known interfaces for communicating with external devices.

The I/O unit 606 decodes packets received via the interconnect 624. In an embodiment, the packets represent commands configured to cause the parallel processing unit 604 to perform various operations. The I/O unit 606 transmits the decoded commands to various other units of the parallel processing unit 604 as the commands may specify. For example, some commands may be transmitted to the front-end unit 608. Other commands may be transmitted to the hub 614 or other units of the parallel processing unit 604 such as one or more copy engines, a video encoder, a video decoder, a power management unit, etc. (not explicitly shown). In other words, the I/O unit 606 is configured to route communications between and among the various logical units of the parallel processing unit 604.

In an embodiment, a program executed by the host processor encodes a command stream in a buffer that provides workloads to the parallel processing unit 604 for processing. A workload may comprise several instructions and data to be processed by those instructions. The buffer is a region in a memory that is accessible (e.g., read/write) by both the host processor and the parallel processing unit 604. For example, the I/O unit 606 may be configured to access the buffer in a system memory connected to the interconnect 624 via memory requests transmitted over the interconnect 624. In an embodiment, the host processor writes the command stream to the buffer and then transmits a pointer to the start of the command stream to the parallel processing unit 604. The front-end unit 608 receives pointers to one or more command streams. The front-end unit 608 manages the one or more streams, reading commands from the streams and forwarding commands to the various units of the parallel processing unit 604.

The front-end unit 608 is coupled to a scheduler unit 610 that configures the various general processing cluster 618 modules to process tasks defined by the one or more streams. The scheduler unit 610 is configured to track state information related to the various tasks managed by the scheduler unit 610. The state may indicate which general processing cluster 618 a task is assigned to, whether the task is active or inactive, a priority level associated with the task, and so forth. The scheduler unit 610 manages the execution of a plurality of tasks on the one or more general processing cluster 618 modules.

The scheduler unit 610 is coupled to a work distribution unit 612 that is configured to dispatch tasks for execution on the general processing cluster 618 modules. The work distribution unit 612 may track a number of scheduled tasks received from the scheduler unit 610. In an embodiment, the work distribution unit 612 manages a pending task pool and an active task pool for each of the general processing cluster 618 modules. The pending task pool may comprise a number of slots (e.g., 32 slots) that contain tasks assigned to be processed by a particular general processing cluster 618. The active task pool may comprise a number of slots (e.g., 4 slots) for tasks that are actively being processed by the general processing cluster 618 modules. As a general processing cluster 618 finishes the execution of a task, that task is evicted from the active task pool for the general processing cluster 618 and one of the other tasks from the pending task pool is selected and scheduled for execution on the general processing cluster 618. If an active task has been idle on the general processing cluster 618, such as while waiting for a data dependency to be resolved, then the active task may be evicted from the general processing cluster 618 and returned to the pending task pool while another task in the pending task pool is selected and scheduled for execution on the general processing cluster 618.

The work distribution unit 612 communicates with the one or more general processing cluster 618 modules via crossbar 616. The crossbar 616 is an interconnect network that couples many of the units of the parallel processing unit 604 to other units of the parallel processing unit 604. For example, the crossbar 616 may be configured to couple the work distribution unit 612 to a particular general processing cluster 618. Although not shown explicitly, one or more other units of the parallel processing unit 604 may also be connected to the crossbar 616 via the hub 614.

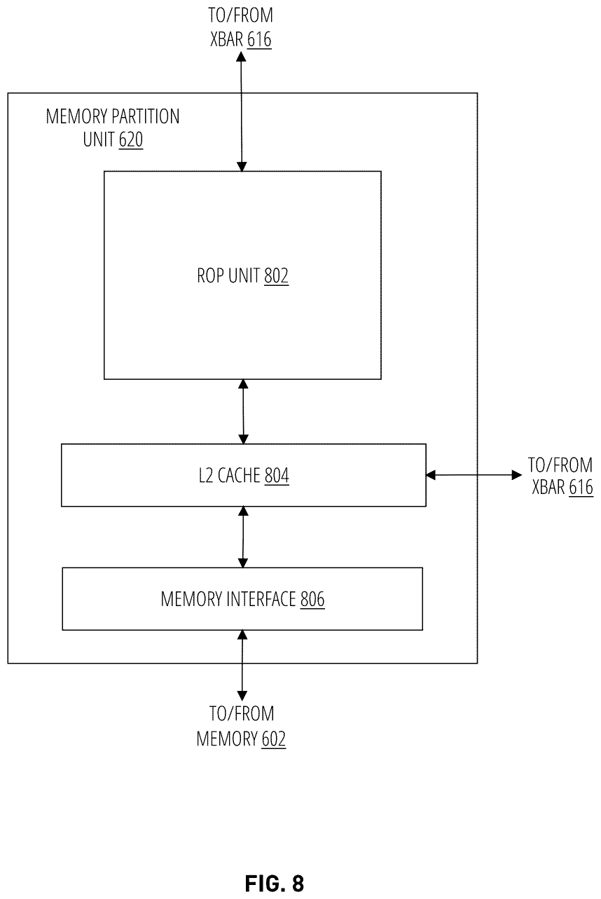

The tasks are managed by the scheduler unit 610 and dispatched to a general processing cluster 618 by the work distribution unit 612. The general processing cluster 618 is configured to process the task and generate results. The results may be consumed by other tasks within the general processing cluster 618, routed to a different general processing cluster 618 via the crossbar 616, or stored in the memory 602. The results can be written to the memory 602 via the memory partition unit 620 modules, which implement a memory interface for reading and writing data to/from the memory 602. The results can be transmitted to another parallel processing unit 604 or CPU via the NVLink 622. In an embodiment, the parallel processing unit 604 includes a number U of memory partition unit 620 modules that is equal to the number of separate and distinct memory 602 devices coupled to the parallel processing unit 604. A memory partition unit 620 will be described in more detail below in conjunction with FIG. 8.

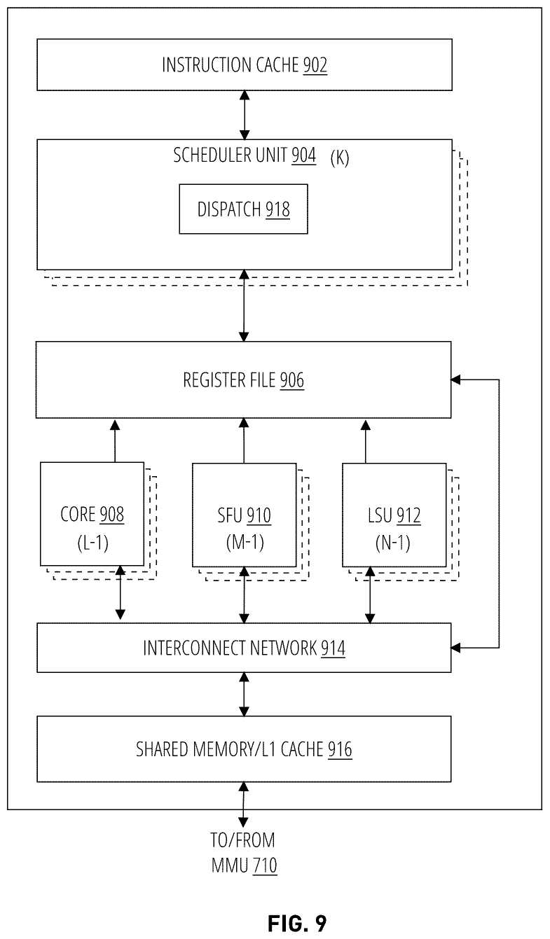

In an embodiment, a host processor executes a driver kernel that implements an application programming interface (API) that enables one or more applications executing on the host processor to schedule operations for execution on the parallel processing unit 604. In an embodiment, multiple compute applications are simultaneously executed by the parallel processing unit 604 and the parallel processing unit 604 provides isolation, quality of service (QoS), and independent address spaces for the multiple compute applications. An application may generate instructions (e.g., API calls) that cause the driver kernel to generate one or more tasks for execution by the parallel processing unit 604. The driver kernel outputs tasks to one or more streams being processed by the parallel processing unit 604. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 9.

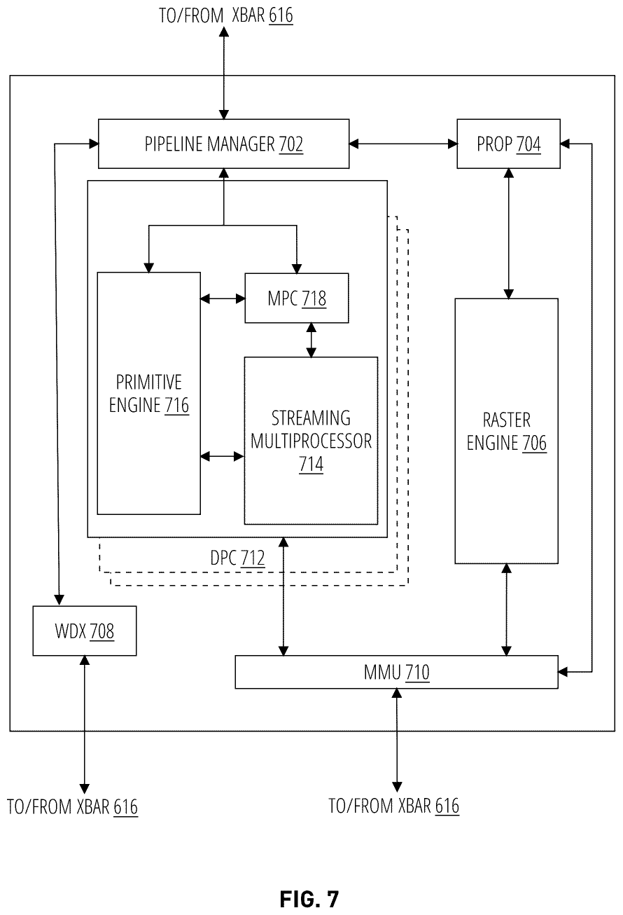

FIG. 7 depicts a general processing cluster 618 of the parallel processing unit 604 of FIG. 6, in accordance with an embodiment. As shown in FIG. 7, each general processing cluster 618 includes a number of hardware units for processing tasks. In an embodiment, each general processing cluster 618 includes a pipeline manager 702, a pre-raster operations unit 704, a raster engine 706, a work distribution crossbar 708, a memory management unit 710, and one or more data processing cluster 712. It will be appreciated that the general processing cluster 618 of FIG. 7 may include other hardware units in lieu of or in addition to the units shown in FIG. 7.

In an embodiment, the operation of the general processing cluster 618 is controlled by the pipeline manager 702. The pipeline manager 702 manages the configuration of the one or more data processing cluster 712 modules for processing tasks allocated to the general processing cluster 618. In an embodiment, the pipeline manager 702 may configure at least one of the one or more data processing cluster 712 modules to implement at least a portion of a graphics rendering pipeline. For example, a data processing cluster 712 may be configured to execute a vertex shader program on the programmable streaming multiprocessor 714. The pipeline manager 702 may also be configured to route packets received from the work distribution unit 612 to the appropriate logical units within the general processing cluster 618. For example, some packets may be routed to fixed function hardware units in the pre-raster operations unit 704 and/or raster engine 706 while other packets may be routed to the data processing cluster 712 modules for processing by the primitive engine 716 or the streaming multiprocessor 714. In an embodiment, the pipeline manager 702 may configure at least one of the one or more data processing cluster 712 modules to implement a neural network model and/or a computing pipeline.

The pre-raster operations unit 704 is configured to route data generated by the raster engine 706 and the data processing cluster 712 modules to a Raster Operations (ROP) unit, described in more detail in conjunction with FIG. 8. The pre-raster operations unit 704 may also be configured to perform optimizations for color blending, organize pixel data, perform address translations, and the like.

The raster engine 706 includes a number of fixed function hardware units configured to perform various raster operations. In an embodiment, the raster engine 706 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 706 comprises fragments to be processed, for example, by a fragment shader implemented within a data processing cluster 712.

Each data processing cluster 712 included in the general processing cluster 618 includes an M-pipe controller 718, a primitive engine 716, and one or more streaming multiprocessor 714 modules. The M-pipe controller 718 controls the operation of the data processing cluster 712, routing packets received from the pipeline manager 702 to the appropriate units in the data processing cluster 712. For example, packets associated with a vertex may be routed to the primitive engine 716, which is configured to fetch vertex attributes associated with the vertex from the memory 602. In contrast, packets associated with a shader program may be transmitted to the streaming multiprocessor 714.

The streaming multiprocessor 714 comprises a programmable streaming processor that is configured to process tasks represented by a number of threads. Each streaming multiprocessor 714 is multi-threaded and configured to execute a plurality of threads (e.g., 32 threads) from a particular group of threads concurrently. In an embodiment, the streaming multiprocessor 714 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 714 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 714 will be described in more detail below in conjunction with FIG. 9.

The memory management unit 710 provides an interface between the general processing cluster 618 and the memory partition unit 620. The memory management unit 710 may provide translation of virtual addresses into physical addresses, memory protection, and arbitration of memory requests. In an embodiment, the memory management unit 710 provides one or more translation lookaside buffers (TLBs) for performing translation of virtual addresses into physical addresses in the memory 602.

FIG. 8 depicts a memory partition unit 620 of the parallel processing unit 604 of FIG. 6, in accordance with an embodiment. As shown in FIG. 8, the memory partition unit 620 includes a raster operations unit 802, a level two cache 804, and a memory interface 806. The memory interface 806 is coupled to the memory 602. Memory interface 806 may implement 32, 64, 128, 1024-bit data buses, or the like, for high-speed data transfer. In an embodiment, the parallel processing unit 604 incorporates U memory interface 806 modules, one memory interface 806 per pair of memory partition unit 620 modules, where each pair of memory partition unit 620 modules is connected to a corresponding memory 602 device. For example, parallel processing unit 604 may be connected to up to Y memory 602 devices, such as high bandwidth memory stacks or graphics double-data-rate, version 5, synchronous dynamic random access memory, or other types of persistent storage.

In an embodiment, the memory interface 806 implements an HBM2 memory interface and Y equals half U. In an embodiment, the HBM2 memory stacks are located on the same physical package as the parallel processing unit 604, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 602 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 604 modules process very large datasets and/or run applications for extended periods.

In an embodiment, the parallel processing unit 604 implements a multi-level memory hierarchy. In an embodiment, the memory partition unit 620 supports a unified memory to provide a single unified virtual address space for CPU and parallel processing unit 604 memory, enabling data sharing between virtual memory systems. In an embodiment the frequency of accesses by a parallel processing unit 604 to memory located on other processors is traced to ensure that memory pages are moved to the physical memory of the parallel processing unit 604 that is accessing the pages more frequently. In an embodiment, the NVLink 622 supports address translation services allowing the parallel processing unit 604 to directly access a CPU's page tables and providing full access to CPU memory by the parallel processing unit 604.

In an embodiment, copy engines transfer data between multiple parallel processing unit 604 modules or between parallel processing unit 604 modules and CPUs. The copy engines can generate page faults for addresses that are not mapped into the page tables. The memory partition unit 620 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 602 or other system memory may be fetched by the memory partition unit 620 and stored in the level two cache 804, which is located on-chip and is shared between the various general processing cluster 618 modules. As shown, each memory partition unit 620 includes a portion of the level two cache 804 associated with a corresponding memory 602 device. Lower level caches may then be implemented in various units within the general processing cluster 618 modules. For example, each of the streaming multiprocessor 714 modules may implement an L1 cache. The L1 cache is private memory that is dedicated to a particular streaming multiprocessor 714. Data from the level two cache 804 may be fetched and stored in each of the L1 caches for processing in the functional units of the streaming multiprocessor 714 modules. The level two cache 804 is coupled to the memory interface 806 and the crossbar 616.

The raster operations unit 802 performs graphics raster operations related to pixel color, such as color compression, pixel blending, and the like. The raster operations unit 802 also implements depth testing in conjunction with the raster engine 706, receiving a depth for a sample location associated with a pixel fragment from the culling engine of the raster engine 706. The depth is tested against a corresponding depth in a depth buffer for a sample location associated with the fragment. If the fragment passes the depth test for the sample location, then the raster operations unit 802 updates the depth buffer and transmits a result of the depth test to the raster engine 706. It will be appreciated that the number of partition memory partition unit 620 modules may be different than the number of general processing cluster 618 modules and, therefore, each raster operations unit 802 may be coupled to each of the general processing cluster 618 modules. The raster operations unit 802 tracks packets received from the different general processing cluster 618 modules and determines which general processing cluster 1 that a result generated by the raster operations unit 802 is routed to through the crossbar 616. Although the raster operations unit 802 is included within the memory partition unit 620 in FIG. 8, in other embodiment, the raster operations unit 802 may be outside of the memory partition unit 620. For example, the raster operations unit 802 may reside in the general processing cluster 618 or another unit.

FIG. 9 illustrates the streaming multiprocessor 714 of FIG. 7, in accordance with an embodiment. As shown in FIG. 9, the streaming multiprocessor 714 includes an instruction cache 902, one or more scheduler unit 904 modules (e.g., such as scheduler unit 610), a register file 906, one or more processing core 908 modules, one or more special function unit 910 modules, one or more load/store unit 912 modules, an interconnect network 914, and a shared memory/L1 cache 916.

As described above, the work distribution unit 612 dispatches tasks for execution on the general processing cluster 618 modules of the parallel processing unit 604. The tasks are allocated to a particular data processing cluster 712 within a general processing cluster 618 and, if the task is associated with a shader program, the task may be allocated to a streaming multiprocessor 714. The scheduler unit 610 receives the tasks from the work distribution unit 612 and manages instruction scheduling for one or more thread blocks assigned to the streaming multiprocessor 714. The scheduler unit 904 schedules thread blocks for execution as warps of parallel threads, where each thread block is allocated at least one warp. In an embodiment, each warp executes 32 threads. The scheduler unit 904 may manage a plurality of different thread blocks, allocating the warps to the different thread blocks and then dispatching instructions from the plurality of different cooperative groups to the various functional units (e.g., core 908 modules, special function unit 910 modules, and load/store unit 912 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 918 unit is configured within the scheduler unit 904 to transmit instructions to one or more of the functional units. In one embodiment, the scheduler unit 904 includes two dispatch 918 units that enable two different instructions from the same warp to be dispatched during each clock cycle. In alternative embodiments, each scheduler unit 904 may include a single dispatch 918 unit or additional dispatch 918 units.

Each streaming multiprocessor 714 includes a register file 906 that provides a set of registers for the functional units of the streaming multiprocessor 714. In an embodiment, the register file 906 is divided between each of the functional units such that each functional unit is allocated a dedicated portion of the register file 906. In another embodiment, the register file 906 is divided between the different warps being executed by the streaming multiprocessor 714. The register file 906 provides temporary storage for operands connected to the data paths of the functional units.

Each streaming multiprocessor 714 comprises L processing core 908 modules. In an embodiment, the streaming multiprocessor 714 includes a large number (e.g., 128, etc.) of distinct processing core 908 modules. Each core 908 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 908 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 908 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 714 also comprises M special function unit 910 modules that perform special functions (e.g., attribute evaluation, reciprocal square root, and the like). In an embodiment, the special function unit 910 modules may include a tree traversal unit configured to traverse a hierarchical tree data structure. In an embodiment, the special function unit 910 modules may include texture unit configured to perform texture map filtering operations. In an embodiment, the texture units are configured to load texture maps (e.g., a 2D array of texels) from the memory 602 and sample the texture maps to produce sampled texture values for use in shader programs executed by the streaming multiprocessor 714. In an embodiment, the texture maps are stored in the shared memory/L1 cache 916. The texture units implement texture operations such as filtering operations using mip-maps (e.g., texture maps of varying levels of detail). In an embodiment, each streaming multiprocessor 714 includes two texture units.

Each streaming multiprocessor 714 also comprises N load/store unit 912 modules that implement load and store operations between the shared memory/L1 cache 916 and the register file 906. Each streaming multiprocessor 714 includes an interconnect network 914 that connects each of the functional units to the register file 906 and the load/store unit 912 to the register file 906 and shared memory/L1 cache 916. In an embodiment, the interconnect network 914 is a crossbar that can be configured to connect any of the functional units to any of the registers in the register file 906 and connect the load/store unit 912 modules to the register file 906 and memory locations in shared memory/L1 cache 916.

The shared memory/L1 cache 916 is an array of on-chip memory that allows for data storage and communication between the streaming multiprocessor 714 and the primitive engine 716 and between threads in the streaming multiprocessor 714. In an embodiment, the shared memory/L1 cache 916 comprises 128 KB of storage capacity and is in the path from the streaming multiprocessor 714 to the memory partition unit 620. The shared memory/L1 cache 916 can be used to cache reads and writes. One or more of the shared memory/L1 cache 916, level two cache 804, and memory 602 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 916 enables the shared memory/L1 cache 916 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 6, are bypassed, creating a much simpler programming model. In the general purpose parallel computation configuration, the work distribution unit 612 assigns and distributes blocks of threads directly to the data processing cluster 712 modules. The threads in a block execute the same program, using a unique thread ID in the calculation to ensure each thread generates unique results, using the streaming multiprocessor 714 to execute the program and perform calculations, shared memory/L1 cache 916 to communicate between threads, and the load/store unit 912 to read and write global memory through the shared memory/L1 cache 916 and the memory partition unit 620. When configured for general purpose parallel computation, the streaming multiprocessor 714 can also write commands that the scheduler unit 610 can use to launch new work on the data processing cluster 712 modules.

The parallel processing unit 604 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 604 is embodied on a single semiconductor substrate. In another embodiment, the parallel processing unit 604 is included in a system-on-a-chip (SoC) along with one or more other devices such as additional parallel processing unit 604 modules, the memory 602, a reduced instruction set computer (RISC) CPU, a memory management unit (MMU), a digital-to-analog converter (DAC), and the like.

In an embodiment, the parallel processing unit 604 may be included on a graphics card that includes one or more memory devices. The graphics card may be configured to interface with a PCIe slot on a motherboard of a desktop computer. In yet another embodiment, the parallel processing unit 604 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 10 is a conceptual diagram of a processing system implemented using the parallel processing unit 604 of FIG. 6, in accordance with an embodiment. The processing system includes a central processing unit 1002, a switch 1004, and multiple parallel processing unit 604 modules each and respective memory 602 modules. The switch 1004 is depicted with dashed lines, indicating that it is optional in some embodiments.

The NVLink 622 provides high-speed communication links between each of the parallel processing unit 604 modules. Although a particular number of NVLink 622 and interconnect 624 connections are illustrated in FIG. 10, the number of connections to each parallel processing unit 604 and the central processing unit 1002 may vary. The switch 1004 interfaces between the interconnect 624 and the central processing unit 1002. The parallel processing unit 604 modules, memory 602 modules, and NVLink 622 connections may be situated on a single semiconductor platform to form a parallel processing module 1006. In an embodiment, the switch 1004 supports two or more protocols to interface between various different connections and/or links.

In another embodiment (not shown), the NVLink 622 provides one or more high-speed communication links between each of the parallel processing unit modules (parallel processing unit 604, parallel processing unit 604, parallel processing unit 604, and parallel processing unit 604) and the central processing unit 1002 and the switch 1004 (when present) interfaces between the interconnect 624 and each of the parallel processing unit modules. The parallel processing unit modules, memory 602 modules, and interconnect 624 may be situated on a single semiconductor platform to form a parallel processing module 1006. In yet another embodiment (not shown), the interconnect 624 provides one or more communication links between each of the parallel processing unit modules and the central processing unit 1002 and the switch 1004 interfaces between each of the parallel processing unit modules using the NVLink 622 to provide one or more high-speed communication links between the parallel processing unit modules. In another embodiment (not shown), the NVLink 622 provides one or more high-speed communication links between the parallel processing unit modules and the central processing unit 1002 through the switch 1004. In yet another embodiment (not shown), the interconnect 624 provides one or more communication links between each of the parallel processing unit modules directly. One or more of the NVLink 622 high-speed communication links may be implemented as a physical NVLink interconnect or either an on-chip or on-die interconnect using the same protocol as the NVLink 622.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1006 may be implemented as a circuit board substrate and each of the parallel processing unit modules and/or memory 602 modules may be packaged devices. In an embodiment, the central processing unit 1002, switch 1004, and the parallel processing module 1006 are situated on a single semiconductor platform.

In an embodiment, each parallel processing unit module includes six NVLink 622 interfaces (as shown in FIG. 10, five NVLink 622 interfaces are included for each parallel processing unit module). The NVLink 622 may be operated exclusively for PPU-to-PPU communication as shown in FIG. 10, or some combination of PPU-to-PPU and PPU-to-CPU, when the central processing unit 1002 also includes one or more NVLink 622 interfaces.

In an embodiment, the NVLink 622 allows direct load/store/atomic access from the central processing unit 1002 to each parallel processing unit module's memory 602. In an embodiment, the NVLink 622 supports coherency operations, allowing data read from the memory 602 modules to be stored in the cache hierarchy of the central processing unit 1002, reducing cache access latency for the central processing unit 1002. In an embodiment, the NVLink 622 includes support for Address Translation Services (ATS), enabling the parallel processing unit module to directly access page tables within the central processing unit 1002. One or more of the NVLink 622 may also be configured to operate in a low-power mode.

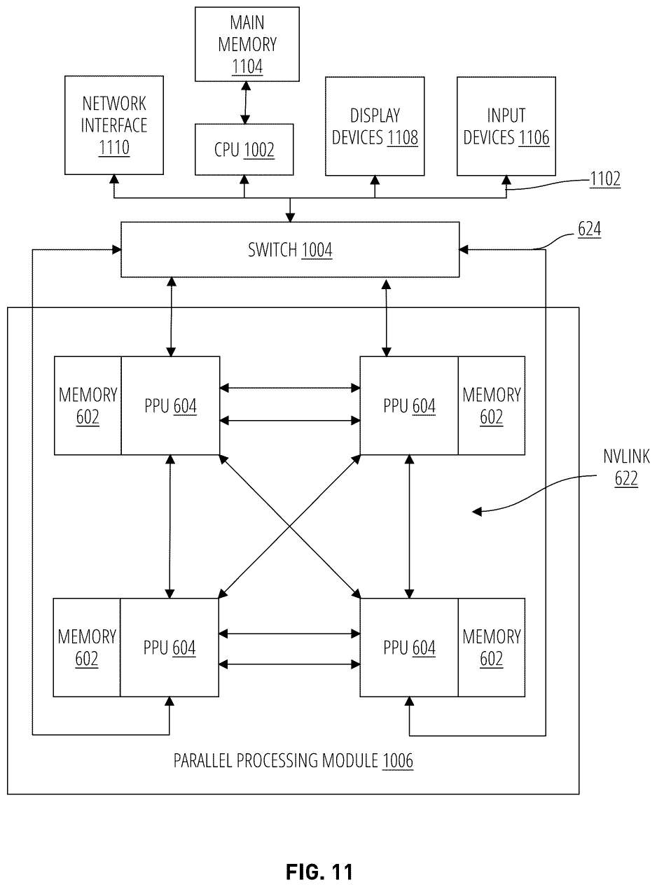

FIG. 11 depicts an exemplary processing system in which the various architecture and/or functionality of the various previous embodiments may be implemented. As shown, an exemplary processing system is provided including at least one central processing unit 1002 that is connected to a communications bus 1102. The communication communications bus 1102 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1104. Control logic (software) and data are stored in the main memory 1104 which may take the form of random access memory (RAM).

The exemplary processing system also includes input devices 1106, the parallel processing module 1006, and display devices 1108, e.g. a conventional CRT (cathode ray tube), LCD (liquid crystal display), LED (light emitting diode), plasma display or the like. User input may be received from the input devices 1106, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1110 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1104 and/or the secondary storage. Such computer programs, when executed, enable the exemplary processing system to perform various functions. The main memory 1104, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.
While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 wafer
104 wafer lot
106 die
108 singulated wafer
110 die tester
112 solver
114 die characteristics
116 product characteristics
118 build settings
120 die pairs
122 CoWoS package
302 action
304 action
306 decision block
308 action
310 action
312 action
314 decision
316 action
502 primary die
504 functional unit
506 functional unit
508 defective functional unit
510 defective functional unit
512 secondary die
514 secondary die
516 secondary die
602 memory
604 parallel processing unit
606 I/O unit
608 front-end unit
610 scheduler unit
612 work distribution unit
614 hub
616 crossbar
618 general processing cluster
620 memory partition unit
622 NVLink
624 interconnect
702 pipeline manager
704 pre-raster operations unit
706 raster engine
708 work distribution crossbar
710 memory management unit
712 data processing cluster
714 streaming multiprocessor
716 primitive engine
718 M-pipe controller
802 raster operations unit
804 level two cache
806 memory interface
902 instruction cache
904 scheduler unit
906 register file
908 core
910 special function unit
912 load/store unit
914 interconnect network
916 shared memory/L1 cache
918 dispatch
1002 central processing unit
1004 switch
1006 parallel processing module
1102 communications bus
1104 main memory
1106 input devices

### 1108 Display Devices

### 1110 Network Interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.
Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S. C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S. C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. An integrated circuit die binning process comprising:
(a) forming a batch of singulated die;
(b) forming a control structure comprising a plurality of intersecting dimensions;
(c) configuring intersection regions of the dimensions with settings indicating a die grouping compatibility;
(d) identifying a first die comprising a lowest die grouping compatibility;
(e) performing one of:
based on the settings indicating die grouping compatibility, randomly selecting a second die for grouping with the first die in a product; or
randomly voiding the first die from one dimension of the control structure; and repeating actions (a) through (e) for more die from the batch of singulated die.

2. The circuit die binning process of claim 1, further comprising:
determining a score for a set of die groupings resulting from repeated application of actions (a)-(e).

3. The circuit die binning process of claim 2, wherein the score comprises a number of the resulting die groupings.

4. The circuit die binning process of claim 2, wherein the score comprises a metric of power efficiency for the die groupings.

5. The circuit die binning process of claim 1, wherein the control structure is two-dimensional.

6. The circuit die binning process of claim 1, further comprising:
on condition that multiple die are identified comprising the lowest die grouping compatibility, randomly selecting the first die from among the multiple die.

7. The circuit die binning process of claim 1, further comprising:
forming a grouping comprising the first die and the second die; and
voiding the first die from all dimensions of the control structure.

8. The circuit die binning process of claim 7, further comprising:
voiding the second die from all dimensions of the control structure.

9. The circuit die binning process of claim 1, wherein the die are grouped in pairs.

10. The circuit die binning process of claim 1, wherein the batch of singulated die is formed from a single silicon wafer.

11. The circuit die binning process of claim 1, wherein the batch of singulated die is formed from multiple silicon wafers.

12. An integrated circuit die binning process comprising:
(a) forming a control structure comprising a plurality of intersecting dimensions;
(b) configuring intersection regions of the dimensions with settings indicating a grouping compatibility for die in a batch of die;
(c) identifying a first die comprising a lowest die grouping compatibility;
(d) randomly selecting a second die for grouping with the first die in a product based on the settings indicating die grouping compatibility;
(e) alternatively to (d), randomly voiding the first die from one dimension of the control structure; and
(f) forming a die bin candidate by repeating actions (a) through (e) for more die from the batch of singulated die.

13. The circuit die binning process of claim 12, further comprising:
repeatedly applying actions (a)-(e) to form a plurality of die bin candidates.

14. The circuit die binning process of claim 13, further comprising:
generating power consumption scores for the die bin candidates.

15. The circuit die binning process of claim 14, further comprising:
selecting one or more of the die bin candidates for a die bin based on the power consumption scores.

16. The circuit die binning process of claim 13, wherein the power consumption scores Sₚ are determined by
$${S}_{p} = - 1 * α * max ( {p}_{i} , P )$$
where pᵢ is the total power value p_{primary}+p_{secondary} for each die grouping pᵢ in a die bin candidate P, and α is a scale factor.

17. The circuit die binning process of claim 13, wherein the power consumption scores Sₚ are determined by
$${S}_{p} = - 1 * α * variance ( P )$$
for die bin candidate P, and α is a scale factor.

18. The circuit die binning process of claim 13, further comprising:
determining a total score Sₜ for each die bin candidate by
$${S}_{t} = β \times {S}_{n} - α * max ( {p}_{i} , P )$$
where pᵢ is the total power value p_{primary}+p_{secondary} for each of Sₙ die groupings pᵢ in the die bin candidate P, and β and α are scale factors.

19. A computer system comprising:
one or more graphics processing units;
a memory configured with instructions that, when applied to the one or more graphics processing units, configure the computer system to:
(a) form a control structure comprising a plurality of intersecting dimensions;
(b) configure intersection regions of the dimensions with settings indicating a grouping compatibility for die in a batch of die;
(c) identify a first die comprising a lowest die grouping compatibility;
(d) randomly select a second die for grouping with the first die in a product based on the settings indicating die grouping compatibility;
(e) alternatively to (d), randomly void the first die from one dimension of the control structure; and
(f) form a die bin candidate by repeating actions (a) through (e) for more die from the batch of singulated die.

20. The circuit die binning process of claim 12, further comprising:
repeatedly apply actions (a)-(e) to form a plurality of die bin candidates;
score the die bin candidates on a power consumption metric; and
select a die bin candidate with a lowest power consumption metric for a die bin.
